(19) United States
(12) Patent Application Publication
(10) Pub. No.: US 2014/0217809 A1
(43) Pub. Date: Aug. 7, 2014

(54) ACTUATOR FOR CONTROLLING BRAKE FLUID PRESSURE

(71) Applicant: DENSO CORPORATION, Kariya-city (JP)

(72) Inventor: Fumitoshi Koyama, Kariya-shi (JP)

(73) Assignee: DENSO CORPORATION, Kariya-city (JP)

(21) Appl. No.: 14/172,120

(22) Filed: Feb. 4, 2014

(30) Foreign Application Priority Data
Feb. 7, 2013 (JP) 2013-022256

(51) Int. Cl. B60T 13/14

(52) U.S. Cl. CPC B60T 13/142
USPC 303/6.01; 303/10

(57) ABSTRACT

The brake actuator includes a housing, a differential pressure control valve, pressure increase control valves, a reservoir, pressure decrease control valves, a pump, an intake system pipeline, and a check valve. The differential pressure control valve is provided in a main pipeline divided into first and second pipelines. The check valve is included in a communication path formed within the housing. The check valve includes a cylindrical pipe member with a hollow portion and an opening portion. A valve body is disposed on the outer circumference of the pipe member. A first path configuring a portion of the intake system pipeline is formed in the pipe member. In the communication path, a gap configuring a portion of the second pipeline is formed outside the pipe member. The check valve allows brake fluid to flow from the first pipeline to the second pipeline through the pipe member and the opening portion.

### CROSS-REFERENCE TO RELATED APPLICATION

This application is based on and claims the benefit of priority from Japanese Patent Application No. 2013-022256, filed on Feb. 7, 2013, the disclosure of which is incorporated herein in its entirety by reference.

### BACKGROUND

1. Technical Field

The present invention relates to an actuator for controlling brake fluid pressure and, in particular, to an actuator (hereinafter referred to as a brake actuator) that is capable of automatically increasing brake fluid pressure (hereinafter referred to as W/C pressure) in a plurality of wheel cylinders (each hereinafter referred to as a W/C).

2. Related Art

In related art, a brake actuator has been proposed in JP-A-2011-046283 that achieves size reduction of a housing and prevents interference between brake pipes. The brake pipes are formed in the housing. In addition, constituent components of a hydraulic circuit, such as control valves and pumps, are assembled in the housing. The brake pipes connect the constituent components. In the brake actuator, a pipe is formed in the housing that leads from a master cylinder (hereinafter referred to as an M/C) to a reservoir. In addition, a circular-cylindrical path member is disposed within the pipe.

As a result of a configuration such as this, an intake system pipeline is configured in a hollow portion of the path member. The intake system pipeline performs intake of brake fluid from the M/C to the reservoir in a hollow portion of the path member. In addition, a portion of a main pipeline is configured by an annular path configured between an inner wall surface of the pipe and an outer circumferential wall of the path member. The main pipeline connects the M/C to each W/C.

In addition, in the brake actuator such as that described above, a differential pressure control valve is included within the main pipe line connecting the M/C and the W/C. The differential pressure control valve provides differential pressure between the M/C side and the W/C side. The W/C pressure is automatically increased in the following manner. The brake fluid on the M/C side is taken in by a pump through the intake system pipeline and the reservoir, and is then discharged between the differential pressure control valve and the W/C on the main pipeline, while the differential pressure control valve in a differential pressure state.

The differential pressure control valve includes a communication path. The communication path allows the brake fluid to flow when a brake pedal is further pressed while the differential pressure control valve in the differential pressure state. As a result of a check valve being included within the communication path, the brake fluid that has been discharged from the reservoir into the main pipeline by the pump is prevented from back-flowing towards the M/C side. The M/C side is further upstream from the differential pressure control valve.

However, in the above-described brake actuator, a structure is used in which the differential pressure control valve includes the communication path and the check valve. Because the communication path and the check valve are included, size reduction of the differential pressure control valve cannot be sufficiently achieved. Therefore, size reduction of the differential pressure control valve and size reduction of the brake actuator are desired.

### SUMMARY

It is thus desired to provide a brake actuator that is capable of achieving further size reduction of a differential pressure control valve provided between a master cylinder and a wheel cylinder.

According to an exemplary embodiment of the present disclosure, there is provide a brake actuator for a brake system having a master cylinder and a plurality of wheel cylinders. The brake actuator configures a hydraulic circuit disposed between the master cylinder and the plurality of wheel cylinders.

The brake actuator includes: a housing: a differential pressure control valve that is provided in a main pipeline connecting the master cylinder and the plurality of wheel cylinders, divides the main pipeline into a first pipeline on the master cylinder side and a second pipeline on the wheel cylinder side, and controls differential pressure between the first pipeline and the second pipeline; pressure increase control valves that are included in a respective branch of the main pipeline that is branched in correspondence with the plurality of wheel cylinders, on a side further towards the plurality of wheel cylinders than the differential pressure control valve; a reservoir into which brake fluid from the second pipeline is discharged through a pressure decrease pipeline connected to the second pipeline on a side further towards the wheel cylinders than the pressure increase control valves; pressure decrease control valves that are included in the pressure decrease pipeline; a pump that is included in a supply pipeline connecting the reservoir and the second pipeline and supplying the brake fluid, and takes in the brake fluid collected in the reservoir and discharges the brake fluid into the second pipeline; and an intake system pipeline that connects the first pipeline and the reservoir, and supplies the brake fluid that is taken in by the pump from the first pipeline side to the reservoir.

In a configuration such as this, a check valve is included in a communication path formed within the housing. The communication path connects the reservoir and the first pipeline. The check valve has a pipe member and a valve body. The pipe member is configured by a cylindrical member having a hollow portion. An opening portion is formed in the pipe member on a side surface of the cylindrical member. The opening portion communicates between the interior of the hollow portion and the outer circumferential side. The valve body is disposed on the outer circumference of the pipe member and opens and closes the opening portion. In a state in which the opening portion is closed by the valve body, fluid-tightness between the interior of the hollow portion and the outer circumferential side of the pipe member is maintained. The interior of the pipe member configures a first path. The first path configures a portion of the intake system pipeline connecting the first pipeline and the reservoir. In addition, the first path configures a portion of the second pipeline configured by a gap in the communication path in the outer circumference of the pipe member. When brake fluid pressure within the first pipeline becomes higher than that within the second pipeline, the opening portion is opened. In a state in which the opening portion is open, the interior of the hollow portion and the outer circumferential side of the pipe member are communicated through the opening portion. The check valve allows the brake fluid to flow from the first pipeline, through the pipe member and the opening portion, to the second pipeline.

As described above, the check valve is included in the communication path to configure the intake system pipeline reaching from the master cylinder to the reservoir. A portion of the intake system pipeline is configured by the hollow portion of the check valve. In addition, the first path that configures a portion of the second pipeline is configured in the outer circumferential portion of the check valve. As a result, the differential pressure control valve is not required to include a communication path or a check valve. Therefore, further size reduction of the differential pressure control valve can be achieved.

### BRIEF DESCRIPTION OF THE DRAWINGS

In the accompanying drawings:

FIG. 1 is a diagram of a basic configuration of a hydraulic circuit in a brake device to which a brake actuator according to a first embodiment of the present invention is applied;

FIG. 2 is a partial cross-sectional view of a portion of the brake actuator;

FIG. 3 is an enlarged cross-sectional view of a differential pressure control valve that is secured to the brake actuator and a surrounding area of the differential pressure control valve;

FIG. 4 is an enlarged view of a broken-line section R in FIG. 2;

FIG. 5A is an enlarged cross-sectional view showing a state in which a check valve is closed;

FIG. 5B is an enlarged cross-sectional view showing a state in which the check valve is open;

FIG. 6A is a cross-sectional view showing a relationship between an overall height of the differential pressure control valve and an eliminated portion according to the first embodiment; and

FIG. 6B is a cross-sectional view showing the overall height of a differential pressure control valve having a conventional structure according to a comparative example.

### DESCRIPTION OF THE EMBODIMENTS

Embodiments of the present invention will hereinafter be described with reference to the drawings. Sections that are the same or equivalent to each other in the embodiments below are described using the same reference numbers.

### First Embodiment

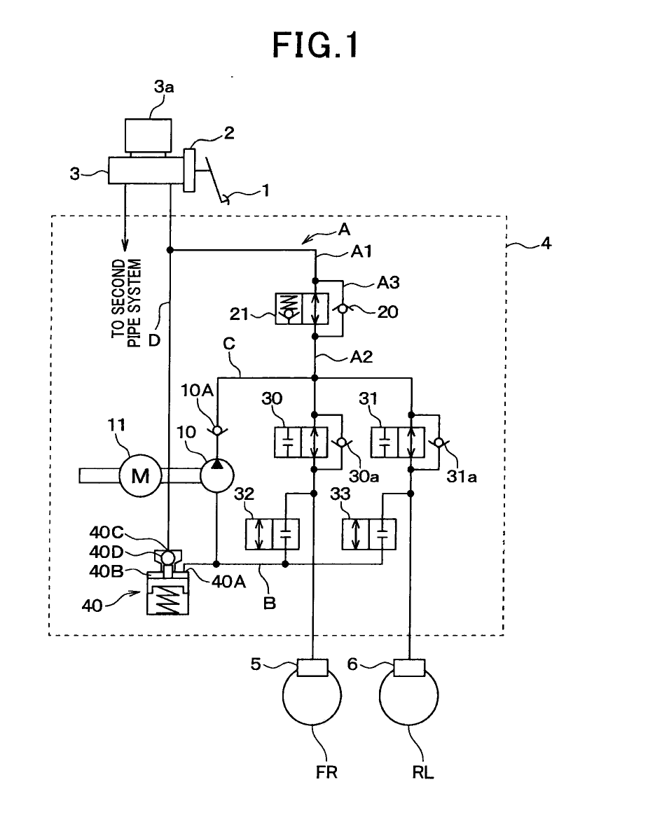

A brake actuator according to a first embodiment of the present invention will be described. First, a basic configuration of a hydraulic circuit in a brake device to which the brake actuator according to the first embodiment is applied will be described with reference to FIG. 1. In FIG. 1, an example is given of a brake device (brake system) that has an X-pipe hydraulic circuit. The X-pipe hydraulic circuit includes a pipe system for a front right wheel and a rear left wheel, and a pipe system for a front left wheel and a rear right wheel. However, the present invention can also be applied accordingly to a front-back pipe and the like.

As shown in FIG. 1, a brake pedal 1 is connected to a booster 2. The booster 2 boosts the pedal pressure applied to the brake pedal 1. The booster 2 includes a push rod and the like. The push rod transmits the boosted pedal pressure to a master cylinder (hereinafter referred to as an M/C) 3. M/C pressure is generated by the push rod pressing a master piston disposed in the M/C 3. The M/C pressure is then transmitted through a brake actuator 4 to a wheel cylinder (hereinafter referred to as a W/C) 5 for a front wheel FR and a W/C 6 for a rear left wheel RL. The brake actuator 4 performs anti-lock braking system (ABS) control, anti-skidding control, and the like. A master reservoir 3a is connected to the M/C 3. Brake fluid is fed into the M/C 3 from the master reservoir 3a. In addition, the master reservoir 3a stores therein surplus brake fluid in the M/C 3.

In the description hereafter, the front right wheel FR and the rear left wheel RL side which is a first pipe system will be described. However, the description similarly applies to the front left wheel FL and the rear right wheel RR side which is a second pipe system.

The brake device includes a pipeline A that serves as a main pipeline connecting to the M/C 3. The pipeline A includes a check valve 20 and a differential pressure control valve 21. The differential pressure control valve 21 is controlled by an electronic control unit (hereinafter referred to as a brake ECU) for performing brake control (not shown).

The pipeline A is divided into two sections by the differential pressure control valve 21. Specifically, the pipeline A is divided into a pipeline A1 and a pipeline A2. The pipeline A1 receives the M/C pressure between the M/C 3 and the differential pressure control valve 21. The pipeline A2 extends from the differential pressure control valve 21 to the W/Cs 5 and 6.

The differential pressure control valve 21 is ordinarily in a communicating state. However, the differential pressure control valve 21 enters a state (differential pressure state) in which the differential pressure control valve 21 generates predetermined differential pressure between the M/C side and the W/C side, such as in the following instances. For example, the differential pressure control valve 21 enters the differential pressure state when sudden braking is applied to the W/Cs 5 and 6 while the M/C pressure is lower than predetermined pressure, when anti-skidding control is performed, and during brake assist. The differential pressure control valve 21 is capable of linearly adjusting a setting value for differential pressure.

A pipeline A3 is provided in parallel with the differential pressure control valve 21. When the brake pedal 1 is further pressed while the differential pressure control valve 21 is in the differential pressure state, the brake fluid is allowed to flow through the pipeline A3. The pipeline 3A includes the check valve 20. The check valve 20 prevents brake fluid that has been discharged from a pressure regulating reservoir 40 to the pipeline A2 by a pump 10, described hereafter, from back-flowing towards the M/C 3 side. The M/C 3 side is further upstream from the differential pressure control valve 21. Characteristic sections of the present embodiment include the configurations of the pipeline A3 and the check valve 20. These sections will be described in detail hereafter.

In addition, in the pipeline A2, the pipeline A branches into two. One branch includes a pressure increase control valve 30. The pressure increase control valve 30 controls increase in brake fluid pressure of the brake fluid being sent to the W/C 5. The other branch includes a pressure increase control valve 31. The pressure increase control valve 31 controls increase in brake fluid pressure of the brake fluid being sent to the W/C 6.

The pressure increase control valves 30 and 31 are each configured as a two-position valve that can be controlled between a communicating state and a blocked state by the brake ECU. When the two-position valve is controlled to be in the communicating state, the M/C pressure, or the brake fluid pressure generated by the brake fluid being discharged from the pump 10, described hereafter, can be applied to the W/Cs 5 and 6. The pressure increase control valves 30 and 31 are each a normally-open valve that is controlled to be in the communicating state at all times during normal braking in which ABS control is not performed.

Safety valves 30a and 31a are respectively provided in parallel with the pressure increase control valves 30 and 31. The safety valves 30a and 31a remove the brake fluid from the side of the W/Cs 5 and 6 when pressing of the brake pedal 1 is stopped and ABS control is completed.

A pipeline B is connected between the pressure increase control valves 30 and 31 and the respective W/Cs 5 and 6 in the pipeline A. The pipeline B serves as a pressure-reducing pipeline. The pipeline B is connected to a first reservoir hole 40A of the pressure regulating reservoir 40. The brake fluid pressure in the W/Cs 5 and 6 is controlled by the brake fluid being sent through the pipeline B to the pressure regulating reservoir 40. As a result, the wheels can be prevented from entering a state of wheel lock.

In addition, pressure decrease control valves 32 and 33 are disposed in the pipeline B. The pressure decrease control valves 32 and 33 can each be controlled between a communicating state and a blocked state by the brake ECU. The pressure decrease control valves 32 and 33 are each a normally-closed valve that is controlled to be in the blocked state at all times during normal braking. The pressure decrease control valves 32 and 33 are set to the communicating state accordingly when the brake fluid is sent to the pressure regulating reservoir 40, described above.

A pipeline C is connected between the differential pressure control valve 21 and the pressure increase control valves 30 and 31 in the pipeline A. The pipeline C serves as a supply pipeline for supplying the brake fluid. The pipeline A and the first reservoir hole 40A of the pressure regulating reservoir 40 are connected via the pipeline C. The pump 10 together with a check valve 10A is provided in the pipeline C. A motor 11 is connected to the pump 10. The motor 11 drives the pump 10. As a result of the pump 10 being driven, the brake fluid collected in a reservoir chamber 40B of the pressure regulating reservoir 40 is pumped out through the pipeline C. The brake fluid is then returned into the pipeline A, further towards the side of the W/Cs 5 and 6 than the differential pressure control valve 21. As a result, the W/C pressure in the W/Cs 5 and 6 is increased.

In addition, a pipeline D is provided such as to connect a second reservoir hole 40C and the M/C 3. The pipeline D serves as an intake system pipeline. The pipeline D is used when the brake fluid in the pipeline A1 is pumped out by the pump 10 being driven and supplied to the pipeline A2, thereby increasing the W/C pressure. For example, during anti-skidding control, brake assist, and the like, the differential pressure control valve 21 is in the differential pressure state, and the pump 10 is driven by the motor 11 being driven. The brake fluid is pumped out from the pipeline A1 through the pipeline D and the pressure regulating reservoir 40. The brake fluid is then supplied to the pipeline A2 side. As a result, the desired W/C pressure can be generated even when M/C pressure is not generated. Anti-skidding control, brake assist control, and the like can be performed.

The pressure regulating reservoir 40 supplies the brake fluid to the pump 10 while controlling of the differential pressure between the brake fluid pressure within the pressure regulating reservoir 40 and the M/C pressure. The first reservoir hole 40A and the second reservoir hole 40C included in the pressure regulating reservoir 40 each communicate with the reservoir chamber 40B.

The first reservoir hole 40A is connected to the pipeline B and the pipeline C. The first reservoir hole 40A receives the brake fluid discharged from the W/Cs 5 and 6 and supplies the brake fluid to the intake side of the pump 10.

The second reservoir hole 40C is connected to the pipeline D. The second reservoir hole 40C receives the brake fluid from the M/C 3 side and supplies the brake fluid to the intake side of the pump 10. The second reservoir hole 40C includes a pressure control valve 40D. The pressure control valve 40D controls the difference in brake fluid pressure between the pipeline D and the interior of the reservoir chamber 40B. In addition, when a predetermined amount of brake fluid is stored in the reservoir chamber 40B the pressure control valve 40D prevents the brake fluid from flowing into the reservoir chamber 40B by closing.

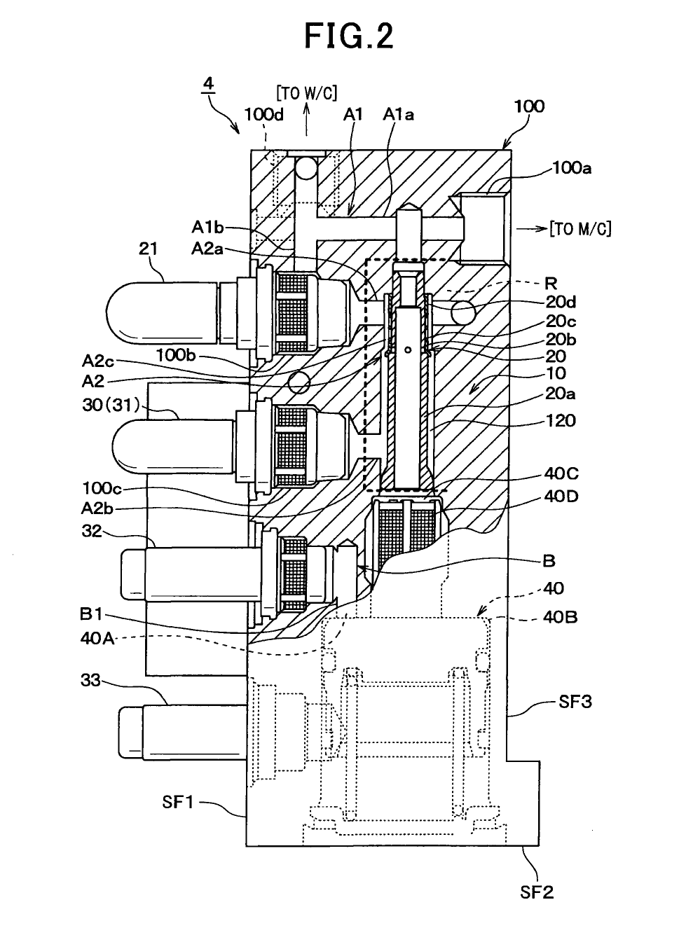

Next, a detailed structure of the brake actuator 4 according to the first embodiment will be described with reference to FIG. 2 to FIG. 4. The brake actuator 4 is mounted in a vehicle such that, for example, the up-down direction on the paper on which FIG. 2 is printed is the top-bottom direction.

The brake actuator 4 shown in FIG. 2 is disposed between the M/C 3 and the W/Cs 5 and 6, as described above. The brake actuator 4 includes a housing 100. The housing 100 is configured by a hexahedron in which the various pipelines A to D are formed. Constituent components, such as the pump 10, the various control valves 21 and 30 to 33, and the pressure regulating reservoir 40, are assembled to the housing 100, thereby configuring the brake actuator 4. The various control valves 21, and 30 to 33 are arrayed on one surface (hereinafter referred to as a first surface SF1) side of the housing 100. The various control valves 21 and 30 to 33 are assembled to the housing 100 by respective tip portions being secured to the housing 100 by crimping or the like.

According to the first embodiment, in order from the top of FIG. 2 is printed, the differential pressure control valve 21, the pressure increase control valve 30 (31), and the pressure decrease control valves 32 and 33 are disposed in an array on the first surface SF1.

In addition, the pump 10 and the motor 11 are assembled to a surface (hereinafter referred to as a third surface SF3) of the housing 100 opposite to the first surface SF1 (not shown).

Furthermore, the pressure regulating reservoir 40 is disposed on a surface (hereinafter referred to as a second surface SF2) of the housing 100 that is not the first surface SF1 or the third surface SF3 opposite to the first surface SF1. The surface on which the pressure regulating reservoir 40 is disposed is substantially perpendicular to the first surface SF1, which is the surface on which the various control valves 21 and 30 to 33 are disposed.

The constituent components are connected by the various pipelines A to D, thereby configuring the hydraulic circuit shown in FIG. 1. Specifically, the connection relationship among the constituent components is as described hereafter.

An M/C connection port 100a is formed in an upper position on the third surface SF3 of the housing 100. The M/C connection port 100a is connected to the M/C 3. A path A1a is formed from the M/C connection port 100a in a perpendicular direction. The path A1a configures a portion of the pipeline A1. In addition, the path A1a is connected to a path A1b, at a tip position in the path A1a on the side opposite to the M/C connection port 100a. The path A1b configures a portion of the pipeline A1. The path A1b is connected to an interior of a first recessing portion 100b, at a position in the path A1b below the path A1a. The first recessing portion 100b is formed on the first surface SF1 and is used to secure the differential pressure control valve 21 to the housing 100. The paths A1a and A1b configure the pipeline A1. A path A2a is formed from a bottom portion of the first recessing portion 100b in a direction perpendicular to the first surface SF1. The path A2a configures a portion of the pipeline A2.

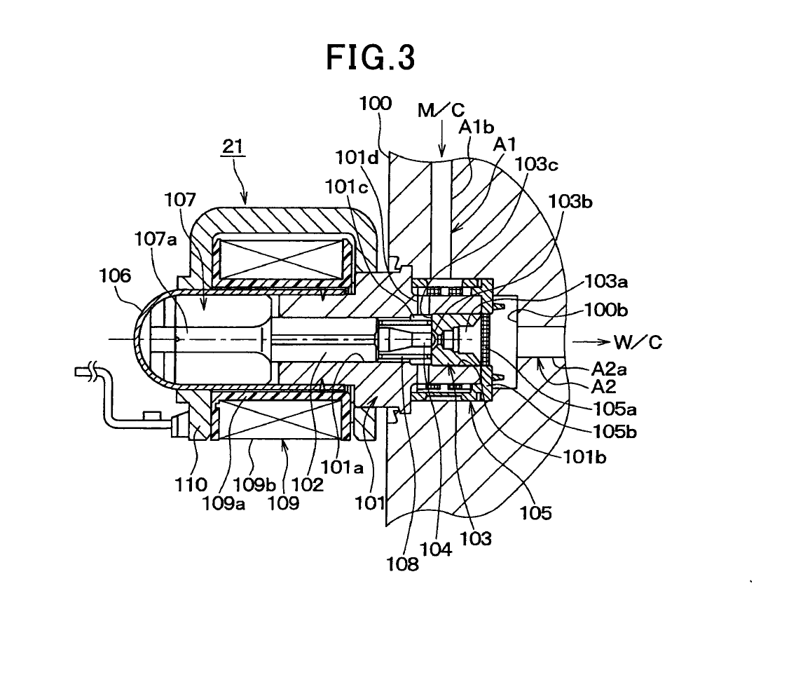

As shown in FIG. 3, the tip position of the differential pressure control valve 21 is secured to the first recessing portion 100b formed in the housing 100. Specifically, the differential pressure control valve 21 has a guide 101, a shaft 102, a seated valve 103, a valve body 104, a filter 105, a sleeve 106, a plunger 107, a spring 108, a coil portion 109, and a yoke 110.

One end side of the guide 101 is inserted into the first recessing portion 100b of the housing 100. The other end of the guide 100 projects outside of the housing 100. A guide hole 101a and a seated-valve insertion hole 101b are formed in the guide 101. The guide hole 101a holds the shaft 102 such as to slide freely. The seated valve 103 is press-fitted into the seated-valve insertion hole 101b. In addition, a communication hole 101d is formed in the guide 101. The communication hole 101d communicates a space 101c to the pipeline A1 on the M/C 3 side. The space 101c is formed in the seated-valve insertion hole 101b and demarcated by the guide 101, the shaft 102, and the seated valve 103.

The shaft 102 is formed by a circular-cylindrical, non-magnetic body. A tip portion of the shaft 102 on the seated valve 103 side projects from the guide hole 101a of the guide 101 and extends to the space 101c. The spherical valve body 104 is formed at the tip of the tip portion of shaft 102.

The seated valve 103 is formed into a circular-cylindrical shape. A flow path 103a is formed in the seated valve 103. The flow path 103a communicates between the space 101c in the guide 101 and the pipeline A2 on the side of the W/Cs 5 and 6. A tapered valve seat 103b is formed in an end portion of the flow path 103a on the space 101c side. The valve body 104 comes into contact with and separates from the valve seat 103b. The space between the valve seat 103b and the valve body 104 is adjusted based on an amount of current sent to the coil portion 109. As a result, the section between the pipeline A1 and the pipeline A2 can be set to the communicating state or the differential pressure state. In addition, the amount of differential pressure during the differential pressure state can be adjusted.

In addition, a spring receiving surface 103c is formed on the end portion of the seated valve 103 on the space 101c side, such as to surround the flow path 103a. The spring receiving surface 103c receives an end of the spring 108.

The filter 105 is attached to a tip of the guide 101 in the direction of insertion into the first recessing portion 100b. The filter 105 is configured by a mesh portion 105a and a frame portion 105b. The filter 105 is structured such that the mesh portion 105a is disposed in a tip portion and a side surface portion of the guide 101 and surrounded by the frame portion 105b. The filter 105 prevents the infiltration of foreign matter from the pipeline A into the communication hole 101d on the outer circumferential surface of the guide 101. The filter 105 also prevents the infiltration of foreign matter from the pipeline A2 into the seated valve 103 at the tip position of the guide 101.

The frame portion 105b is pressed against the bottom surface of the first recessing section 100b and the tip of the guide 101. Fluid-tightness between the pipeline A1 and the pipeline A2 is ensured between the frame portion 105b and the bottom surface of the first recessing portion 100b, and the frame portion 105b and the tip of the guide 101.

The sleeve 106 is fitted onto the outer circumferential side of the other end of the guide 101. The sleeve 106 is composed of a non-magnetic metal and is formed into a bottomed circular-cylindrical shape of which one end is open. The bottom surface has a substantially spherical shape.

The plunger 107 is disposed in a space formed and demarcated by the sleeve 106 and the guide 101. The plunger 107 is a substantially circular-columnar member composed of a magnetic metal. The plunger 107 is capable of sliding within the sleeve 106. A plunger groove 107a is formed on the outer circumferential surface of the plunger 107. The plunger groove 107a extends from one end to the other end of the plunger 107. The plunger groove 107a communicates between a space in the sleeve 106 on the bottom surface side of the sleeve 106 and a space between the opposing surfaces of the plunger 107 and the guide 101.

The spring 108 is sandwiched between the shaft 102 and the seated valve 103. The spring 108 biases the shaft 102 towards the plunger 107 side. As a result, the shaft 102 and the plunger 107 are in contact at all times and are able to move integrally.

The coil portion 109 has a spool 109a and a coil 109b. The spool 109a is disposed around the sleeve 106. The coil 109b is wound around the spool 109a. The coil portion 109 forms a magnetic field as a result of the coil 109b being energized. The plunger 107 is driven by the electromagnetic force generated by the coil 109b being energized. The yoke 110 is disposed such as to surround the outer circumference of the coil portion 109. The yoke 110 functions as a magnetic path member.

The differential pressure control valve 21 is configured to have a structure such as that described above. As described above, only the flow path 103a is included in the differential pressure control valve 21. The flow path 103a is provided in the seated valve 103 as a path connecting the pipeline A1 and the pipeline A2. The structure of the differential pressure control valve 21 does not include the check valve 20 and the pipeline A3. The path A2a is formed from the tip position of the differential pressure control valve 21 configured as described above.

On the other hand, a communication path 120 is formed such as to extend from the second surface SF2 of the housing 100 in a perpendicular direction. The communication path 120 is connected further towards the path A1a side than the tip of the pressure regulating reservoir 40. The path A2a is also connected to the communication path 120. Furthermore, a path A2b is also connected to the communication path 120. The path A2b is formed by a second recessing portion 100c and configures a portion of the pipeline A2. The tip of the pressure increase control valve 30 (31) is secured to the second recessing portion 100c. The path A2b configures a portion of the pipeline A2. The check valve 20 is included in the communication path 120.

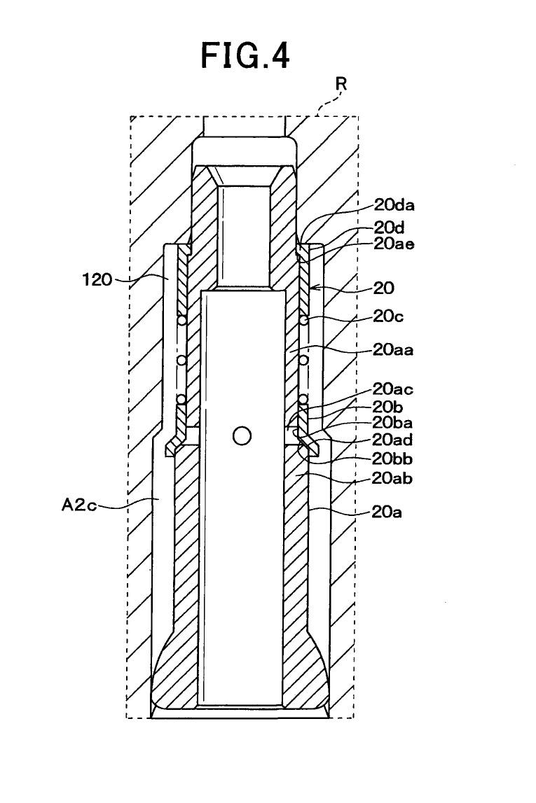

As shown in FIG. 2 and FIG. 4, the check valve 20 is formed within the communication path 120, from a position above the path A2a to a position below the path A2b. The check valve 20 is composed of a cylindrical member having a hollow portion. According to the first embodiment, the check valve 20 is composed of a circular-cylindrical member. A radial-direction cross-sectional area of the check valve 20 is smaller than a radial-direction cross-sectional area of the communication path 120. Therefore, a gap that is a portion of the communication path 120 remains on the outer circumference of the check valve 20. The gap serves as a path A2c that configures a portion of the pipeline A2. The path A2c connects the path A2a and the path A2b.

An outer wall surface of the end portion of the check valve 20 on the path A1a side, at a position closer to the path A1a side than to the path A2a, is in close contact with an inner wall surface of the communication path 120. Sealing is ensured therebetween. In addition, the outer wall surface of the end portion of the check valve 20 on the pressure regulating reservoir 40 side, at a position further towards the pressure regulating reservoir 40 than the path A2b, is in close contact with the inner wall surface of the communication path 120. Sealing is ensured therebetween. As a result, the interior of the hollow portion of the check valve 20 serves as a portion of the pipeline D, and connects between the M/C 3 and the pressure regulating reservoir 40.

For example, the check valve 20 is inserted into the communication path 120 before the pressure regulating reservoir 40 is assembled to the housing 100. Dimensions of both end portions of the check valve 20 are designed such that each end portion is press-fitted into the communication path 120. As a result, sealing between the outer wall surface on both end portions of the press-fitted check valve 20 and the inner wall surface of the communication path 120 can be ensured.

More specifically, as shown in FIG. 4, the check valve 20 includes a pipe member 20a, a valve body 20b, a spring 20c, and a stopper 20d.

The pipe member 20a is a cylindrical member that is disposed from a position above the path Ata to a position below the path A2b, as described above. According to the first embodiment, the pipe member 20a is a circular-cylindrical member. The outer wall surface of both end portions of the pipe member 20a is in close contact with the inner wall surface of the communication path 120. The pipe member 20a has a stepped shape in which the outer diameter is changed at an intermediate position in the axial direction. The path A1a side of the pipe member 20a is a small diameter portion 20aa. The pressure regulating reservoir 40 side of the pipe member 20a is a large diameter portion 20ab. The large diameter portion 20ab has a larger outer diameter than the small diameter portion 20aa.

In addition, an opening portion 20ac is formed in the pipe member 20a. The opening portion 20ac communicates between the interior of the hollow portion and the path A2c on the outer circumferential side. The opening portion 20ac is formed in the small diameter portion 20aa of the pipe member 20a. The opening portion 20ac is formed in a position in the small diameter portion 20aa at the border with the large diameter portion 20ab. A plurality of opening portions 20ac are formed at even intervals in the circumferential direction.

Specifically, a border portion between the small diameter portion 20aa and the large diameter portion 20ab is formed into a tapered surface 20ad. The outer diameter of the tapered surface 20ad gradually decreases from the large diameter portion 20ab side towards the small diameter portion 20aa side. The opening portions 20ac are formed such as to reach from the small diameter portion 20aa to the tapered surface 20ad.

Furthermore, a locking portion 20ae is formed in the small diameter portion 10aa further towards the side opposite to the large diameter portion 20ab than the opening portions 20ac. The outer diameter of the locking portion 20ae is partially further decreased. The stopper 20d is locked to the locking portion 20ae as described hereafter.

The valve body 20b opens and closes the opening portions 20ac. The valve body 20b is formed from a position in the small diameter portion 20aa of the pipe member 20a further towards the path A1a side than the opening portions 20ac, along the small diameter portion 20aa and the tapered surface 20ad. The valve body 20b is formed such as to surround the small diameter portion 20aa and the tapered surface 20ad.

In other words, the interior of the valve body 20b has a circular-cylinder inner circumferential surface 20ba and a tapered surface 20bb. The circular-cylinder inner circumferential surface 20ba is placed in contact with the small diameter portion 20aa along the pipe member 20a. The tapered surface 20bb is placed in contact with the tapered surface 20ad. The circular-cylinder inner circumferential surface 20ba is slid along the outer circumferential surface of the small diameter portion 20aa. As a result, the valve body 20b is capable of opening and closing the opening portions 20ac.

Specifically, the valve body 20b closes the opening portions 20ac when the valve body 20b is in contact with the tapered surface 20ad. The valve body 20b opens the opening portion 20ac when the valve body 20b separates from the tapered surface 20ad. When the valve body 20b opens the opening portions 20ac, the interior of the hollow portion of the pipe member 20a and the pipeline A2 are connected. Then, because the hollow portion of the pipe member 20a is connected to the pipeline A1, the valve body 20b can open and close the section between the pipeline A1 and the pipeline A2 by opening and closing the opening portions 20ac.

The valve body 20b is merely required to open and close the opening portions 20ac. Therefore, the valve body 20b is merely required to be formed such as to reach from the small diameter portion 20aa to the tapered surface 20ad. However, according to the first embodiment, the valve body 20b is formed such as to also surround a portion of the large diameter portion 20ab on the small diameter portion 20aa side. As a result, sealing when the opening portions 20ac are closed by the valve body 20b can be further ensured.

The spring 20c is disposed along the outer circumferential surface of the small diameter portion 20aa. The spring 20c comes into contact with one end of the valve body 20b and biases the valve body 20b in the direction in which the opening portions 20ac are closed.

The stopper 20d is a circular-cylindrical member that is disposed on the outer circumferential surface of the end portion of the pipe member 20a on the path A1a side. The stopper 20d sets the amount of insertion of the pipe member 20a into the communication path 120. In addition, the stopper 20d configures a receiving surface for the spring 20. A locking portion 20da is formed on the end portion of the stopper 20d on the side opposite to the spring 20. The inner diameter of the locking portion 20da is made smaller. The locking portion 20da engages with the locking portion 20ae formed at the tip of the small diameter portion 20aa.

As a result, when the stopper 20d comes into contact with the communication path 120 of which the inner diameter is partially smaller than the outer diameter of the stopper 20d, insertion of the pipe member 20a into the communication path 120 is stopped as a result of the locking sections 20ae and 20da engaging. The check valve 20 is configured by a structure such as that described above.

In addition, the first reservoir hole 40A of the pressure regulating reservoir 40 and the pressure decrease control valves 32 and 33 are connected to a path B1. The path B1 configures a portion of the pipeline B. Furthermore, a path is also formed in the path B1 on a cross-section other than that shown in FIG. 2 (not shown). The path configures a portion of the pipeline C that connects to the pump 10. In addition, a portion of the pipeline C that connects from the pump 10 to the pipeline A2 is formed, thereby configuring the pipeline C. In addition, on a cross-section other than that shown in FIG. 2, a path is formed that connects the pressure increase control valves 30 and 31 in the pipeline A2 and the W/C connection port 100d connecting to the W/Cs 5 and 6 (not shown). The path connecting the pressure increase control valves 30 and 31 and the W/C connection port 100d, and the paths A2a to A2c configure the pipeline A2. The brake actuator 4 is configured by a structure such as that described above.

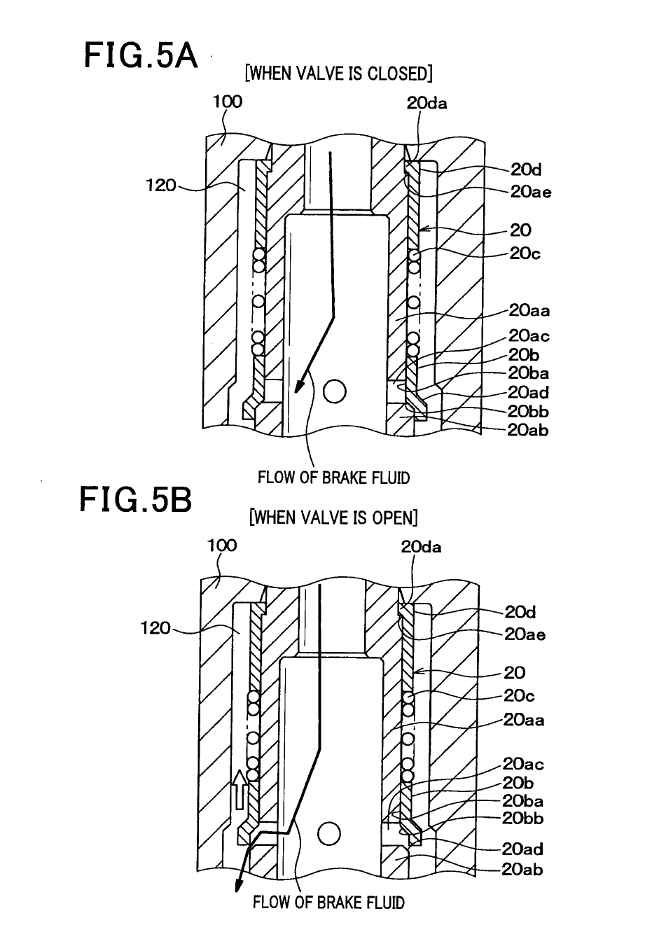

Next, operations of the brake actuator 4 configured as described above will be described together with the operations of the check valve 20, with reference to FIG. 2, FIG. 5A, and FIG. 5B.

First, during normal braking, the M/C pressure is generated in accompaniment with the brake pedal 1 being pressed. The M/C pressure is then transmitted through the M/C connection port 100a into the brake actuator 4. At this time, there is no pressure difference between the interior of the hollow portion of the pipe member 20a and the outer circumferential side of the pipe member 20a. Therefore, the check valve 20 is in a state in which the opening portions 20ac are closed by the valve body 20b, as shown in FIG. 5A.

As a result, the M/C pressure is transmitted to the W/Cs 5 and 6 only by a route from the pipeline A1 through the pipeline A2, shown in FIG. 2. The pipeline A1 is configured by the paths A1a and A1b. The pipeline A2 is configured by the differential pressure control valve 21, the paths A2a to A2c, and the like.

During ABS control, the pressure increase control valves 30 and 31, and the pressure decrease control valves 32 and 33 are driven accordingly. In addition, the motor 11 is driven, thereby driving the pump 10. At this time, pressure difference may occur between the interior of the hollow portion of the pipe member 20a and the outer circumferential side of the pipe member 20a. However, the pressure difference is not large. Therefore, the check valve 20 is in the closed state, as shown in FIG. 5A.

As a result, pressure is reduced in the W/Cs 5 and 6 by the brake fluid being discharged from the pipeline A2 to the pressure regulating reservoir 40. Alternatively, pressure is increased in the W/Cs 5 and 6 by the pump 10 taking in the brake fluid collected in the pressure regulating reservoir 40 and discharging the brake fluid towards the pipeline A2.

Furthermore, during anti-skidding control and brake assist control, the differential pressure control valve 21 is set to the differential pressure state. In addition, the brake fluid is supplied from the pipeline A2 on the M/C 3 side, through the pipeline D and the pressure regulating reservoir 40, to the pipeline A2 on the side of the W/Cs 5 and 6, by the motor 11 being driven. As a result, the W/C pressure can be generated based on the differential pressure generated by the differential pressure control valve 21.

At this time, the brake fluid pressure is lower in the interior of the hollow portion of the pipe member 20a than on the outer circumferential side of the pipe member 20a. Therefore, the check valve 20 is in the closed state, as shown in FIG. 5A. As a result, the brake fluid is sent through the pipeline D, configured by the pipe member 20a, and the pressure regulating reservoir 40 towards the pipeline A2 side.

When a driver further presses the brake pedal 1 in this state, because the differential pressure control valve 21 is in the differential pressure state, the brake fluid cannot be suddenly sent from the pipeline A2 through the differential pressure control valve 21 into the pipeline A2. Therefore, in the check valve 20, the brake fluid pressure within the hollow portion of the pipe member 20a becomes higher than the brake fluid pressure on the outer circumferential side of the pipe member 20a. The valve body 20b slides over the outer circumferential surface of the small diameter portion 20aa, as shown in FIG. 5B, thereby opening the opening portions 20ac.

Specifically, the brake fluid pressure within the opening portions 20ac also increases. Therefore, high pressure is applied to the tapered surface 20bb of the valve body 20b, overriding the force applied by the spring 20c to bias the valve body 20b in the direction in which the opening portions 20ac are closed. The valve body 20b is thereby moved towards the stopper 20d. As a result, the valve body 20b separates from the tapered surface 20ad and the opening portions 20ac are opened. The pipeline A3 is set to a communicating state.

As described above, when the driver further presses the brake pedal 1, even when the differential pressure control valve 21 is in the differential pressure state, the check valve 20 opens and the pipeline A3 is set to the communicating state. Therefore, the brake fluid is allowed to flow from the pipeline A1 through the pipeline A3 to the pipeline A2. Increase in W/C pressure corresponding to a request by the driver can be performed with favorable responsiveness.

As described above, according to the first embodiment, the check valve 20 is included within the communication path 120 for configuring the pipeline D from the M/C 3 to the pressure regulating reservoir 40. A portion of the pipeline D is configured by the hollow portion of the check valve 20. In addition, the path A2c configuring a portion of the pipeline A2 is formed on the outer circumferential portion of the check valve 20. As a result, the differential pressure control valve 21 is not required to include a communication path and a check valve. Therefore, further size reduction of the differential pressure control valve 21 can be achieved.

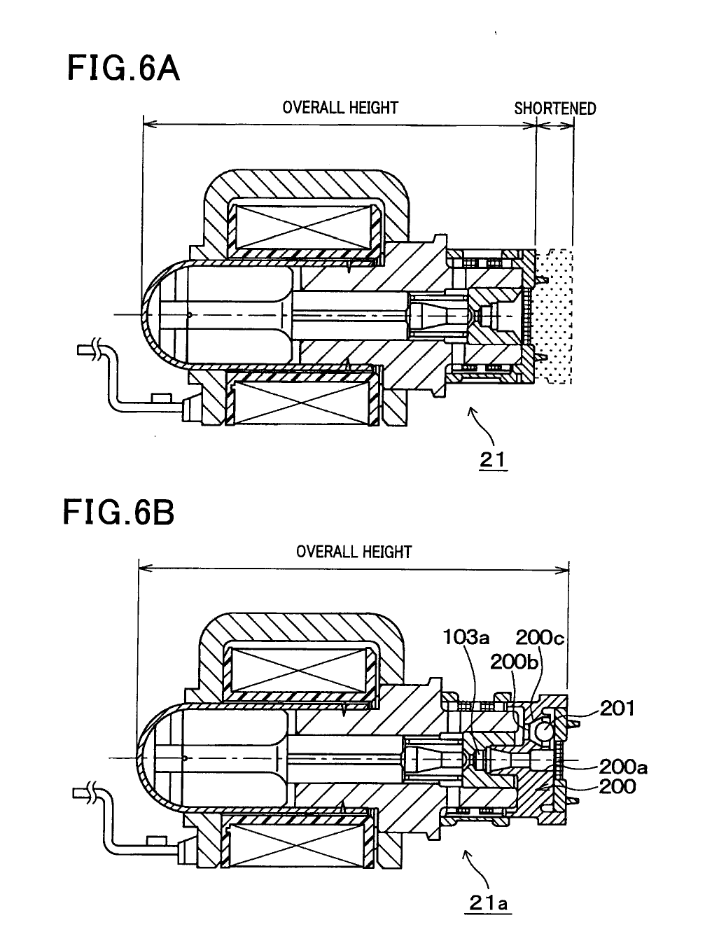

FIG. 6A shows a relationship between an overall height of the differential pressure control valve 21 and an eliminated portion. For comparison, FIG. 6B shows the overall height of a differential pressure control valve 21a having a conventional structure according to a comparative example.

As shown in FIG. 6B, the differential pressure control valve 21a according to the comparative example includes constituent components 200 and 201 on the side further towards the tip than the seated valve 103. The constituent components 200 and 201 serve as the pipeline A3 and the check valve 20 according to the first embodiment. The constituent component 200 includes a path 200a and a path 200b. The path 200a configures a portion of the pipeline A2 connecting to the flow path 103a. The path 200b is provided in a position shifted from the path 200a and is equivalent to the pipeline A3. A valve seat 200c is formed in the path 200b. The constituent component 201 is a valve body that comes into contact with and separates from the valve seat 200c. The constituent component 201 is configured by a ball valve.

As a result of the constituent components 200 and 201 structured in this way being included, the roles of the pipeline A3 and the check valve 20 according to the first embodiment are achieved. Therefore, space for disposing the constituent components 200 and 201 is required in the differential pressure control valve 21a according to the comparative example shown in FIG. 6B.

On the other hand, as shown in FIG. 6A, the constituent components 200 and 201 required in the differential pressure control valve 21a according to the comparative example shown in FIG. 6B can be eliminated in the differential pressure control valve 21 according to the first embodiment. Therefore, the overall height of the differential control valve 21 can be shortened. Further size reduction of the differential pressure control valve 21 can be achieved.

### Other Embodiments

The present invention is not limited to the above-described embodiment. Modifications can be made accordingly within the scope recited in the scope of claims.

For example, the spring 20c is included in the check valve 20. However, in an instance in which the brake actuator 4 is mounted in a vehicle such that the up-down direction in FIG. 2 is the top-bottom direction, the opening portions 20ac can be configured to be closed by the dead weight of the valve body 20b, even without the spring 20c.

However, the valve body 20b is required to seal the opening portions 20ac. Therefore, sliding resistance is generated between the valve body 20b and the pipe member 20a to a degree that sealing between the valve body 20b and the pipe member 20a can be ensured. As a result, closing operation of the opening portions 20ac by the valve body 20b can be more favorably performed if the spring 20c is included.

In addition, an example is given in which the pressure regulating reservoir 40 is included as the reservoir. However, the reservoir may be simple reservoir that does not include a pressure regulating valve.

What is claimed is:

1. A brake actuator for a brake system having a master cylinder and a plurality of wheel cylinders, the brake actuator configuring a hydraulic circuit disposed between the master cylinder and the plurality of wheel cylinders, the brake actuator comprising:
a housing:
a differential pressure control valve that is provided in a main pipeline connecting the master cylinder and the plurality of wheel cylinders, divides the main pipeline into a first pipeline on the master cylinder side and a second pipeline on the wheel cylinder side, and controls differential pressure between the first pipeline and the second pipeline;
pressure increase control valves that are included in a respective branch of the main pipeline that is branched in correspondence with the plurality of wheel cylinders, on a side further towards the plurality of wheel cylinders than the differential pressure control valve;
a reservoir into which brake fluid from the second pipeline is discharged through a pressure decrease pipeline connected to the second pipeline on a side further towards the wheel cylinders than the pressure increase control valves;
pressure decrease control valves that are included in the pressure decrease pipeline;
a pump that is included in a supply pipeline connecting the reservoir and the second pipeline and supplying the brake fluid, and takes in the brake fluid collected in the reservoir and discharges the brake fluid into the second pipeline;
an intake system pipeline that connects the first pipeline and the reservoir, and supplies the brake fluid that is taken in by the pump from the first pipeline side to the reservoir; and
a check valve that is included in a communication path formed within the housing, the communication path connecting the reservoir and the first pipeline,
the check valve including a pipe member and a valve body,
the pipe member being configured by a cylindrical member having a hollow portion, an opening portion being formed in the pipe member on a side surface of the cylindrical member, the opening portion communicating between an interior of the hollow portion and an outer circumferential side of the cylindrical member,
the valve body being disposed on an outer circumference of the pipe member and opens and closes the opening portion,
fluid-tightness between an interior of the hollow portion and an outer circumferential side of the pipe member being maintained in a state in which the opening portion is closed by the valve body,
a first path being configured by an interior of the pipe member, the first path configuring a portion of the intake system pipeline connecting the first pipeline and the reservoir,
a portion of the second pipeline being configured by a gap that is formed outside the outer circumference of the pipe member in the communication path,
the opening portion being opened when brake fluid pressure within the first pipeline becomes higher than that within the second pipeline,
the interior of the hollow portion and the outer circumferential side of the pipe member being communicated through the opening portion in a state in which the opening portion is open,
the check valve allowing the brake fluid to flow from the first pipeline, through the pipe member and the opening portion, to the second pipeline.

2. The brake actuator according to claim 1, wherein:
the pipe member is configured by a circular-cylindrical member
the circular-cylindrical member having a stepped shape which is formed by a small diameter portion, a large diameter portion, and a first tapered surface,
the large diameter portion having a larger outer diameter than the small diameter portion,
the first tapered surface having an outer diameter that gradually decreases from a side of the large diameter portion towards a side of the small diameter portion; and
the valve body has a circular-cylinder inner circumferential surface and a second tapered surface,
the circular-cylinder inner circumferential surface being placed in contact with the small diameter portion of the pipe member along the first tapered surface of the pipe member from the small diameter portion,
the second tapered surface being placed in contact with the first tapered surface of the pipe member,
the pipe member being slid by the valve body such that the opening portion is opened, when brake fluid pressure within the hollow portion of the pipe member becomes higher than brake fluid pressure on the outer circumferential side of the pipe member.

3. The brake actuator according to claim 2, wherein:
the housing has a first surface and a second surface substantially perpendicular to the first surface,
the differential pressure control valve, the pressure increase control valves, and the pressure decrease control valves are disposed in the first surface,
the reservoir is disposed in the second surface;
a second path and a third path are formed in the housing,
the second path being connected to the communication path via a first recessing portion,
the first recessing portion being formed on the first surface to which the differential pressure control valve is secured,
the third path being connected to the communication path via a second recessing portion,
the second recessing portion being formed on the first surface to which the pressure decrease control valves are secured,
the second path and the third path are connected via the first path, a part of the second pipeline being configured by the first path, the second path, and the third path.

4. The brake actuator according to claim 1, wherein:
the housing has a first surface and a second surface substantially perpendicular to the first surface,
the differential pressure control valve, the pressure increase control valves, and the pressure decrease control valves are disposed in the first surface,
the reservoir is disposed in the second surface;
a second path and a third path are formed in the housing,
the second path being connected to the communication path via a first recessing portion,
the first recessing portion being formed on the first surface to which the differential pressure control valve is secured,
the third path being connected to the communication path via a second recessing portion,
the second recessing portion being formed on the first surface to which the pressure decrease control valves are secured,
the second path and the third path are connected via the first path, a part of the second pipeline being configured by the first path, the second path, and the third path.

5. A brake system comprising:
a master cylinder;
a plurality of wheel cylinders; and
a brake actuator that configures a hydraulic circuit disposed between the master cylinder and the plurality of wheel cylinders, the brake actuator comprising:
a housing:
a differential pressure control valve that is provided in a main pipeline connecting the master cylinder and the plurality of wheel cylinders, divides the main pipeline into a first pipeline on the master cylinder side and a second pipeline on the wheel cylinder side, and controls differential pressure between the first pipeline and the second pipeline;
pressure increase control valves that are included in a respective branch of the main pipeline that is branched in correspondence with the plurality of wheel cylinders, on a side further towards the plurality of wheel cylinders than the differential pressure control valve;
a reservoir into which brake fluid from the second pipeline is discharged through a pressure decrease pipeline connected to the second pipeline on a side further towards the wheel cylinders than the pressure increase control valves;
pressure decrease control valves that are included in the pressure decrease pipeline;
a pump that is included in a supply pipeline connecting the reservoir and the second pipeline and supplying the brake fluid, and takes in the brake fluid collected in the reservoir and discharges the brake fluid into the second pipeline;
an intake system pipeline that connects the first pipeline and the reservoir, and supplies the brake fluid that is taken in by the pump from the first pipeline side to the reservoir; and
a check valve that is included in a communication path formed within the housing, the communication path connecting the reservoir and the first pipeline,
the check valve including a pipe member and a valve body,
the pipe member being configured by a cylindrical member having a hollow portion, an opening portion being formed in the pipe member on a side surface of the cylindrical member, the opening portion communicating between an interior of the hollow portion and an outer circumferential side of the cylindrical member,
the valve body being disposed on an outer circumference of the pipe member and opens and closes the opening portion,
fluid-tightness between an interior of the hollow portion and an outer circumferential side of the pipe member being maintained in a state in which the opening portion is closed by the valve body,
a first path being configured by an interior of the pipe member, the first path configuring a portion of the intake system pipeline connecting the first pipeline and the reservoir,
a portion of the second pipeline being configured by a gap that is formed outside the outer circumference of the pipe member in the communication path,
the opening portion being opened when brake fluid pressure within the first pipeline becomes higher than that within the second pipeline,
the interior of the hollow portion and the outer circumferential side of the pipe member being communicated through the opening portion in a state in which the opening portion is open,
the check valve allowing the brake fluid to flow from the first pipeline, through the pipe member and the opening portion, to the second pipeline.

6. The brake system according to claim 5, wherein:
the pipe member is configured by a circular-cylindrical member
the circular-cylindrical member having a stepped shape which is formed by a small diameter portion, a large diameter portion, and a first tapered surface,
the large diameter portion having a larger outer diameter than the small diameter portion,
the first tapered surface having an outer diameter that gradually decreases from a side of the large diameter portion towards a side of the small diameter portion; and
the valve body has a circular-cylinder inner circumferential surface and a second tapered surface,
the circular-cylinder inner circumferential surface being placed in contact with the small diameter portion of the pipe member along the first tapered surface of the pipe member from the small diameter portion,
the second tapered surface being placed in contact with the first tapered surface of the pipe member,
the pipe member being slid by the valve body such that the opening portion is opened, when brake fluid pressure within the hollow portion of the pipe member becomes higher than brake fluid pressure on the outer circumferential side of the pipe member.

7. The brake system according to claim 6, wherein:
the housing has a first surface and a second surface substantially perpendicular to the first surface,
the differential pressure control valve, the pressure increase control valves, and the pressure decrease control valves are disposed in the first surface,
the reservoir is disposed in the second surface;
a second path and a third path are formed in the housing,
the second path being connected to the communication path via a first recessing portion,
the first recessing portion being formed on the first surface to which the differential pressure control valve is secured,
the third path being connected to the communication path via a second recessing portion,
the second recessing portion being formed on the first surface to which the pressure decrease control valves are secured,
the second path and the third path are connected via the first path, a part of the second pipeline being configured by the first path, the second path, and the third path.

8. The brake system according to claim 5, wherein:
the housing has a first surface and a second surface substantially perpendicular to the first surface,
the differential pressure control valve, the pressure increase control valves, and the pressure decrease control valves are disposed in the first surface,
the reservoir is disposed in the second surface;
a second path and a third path are formed in the housing,
the second path being connected to the communication path via a first recessing portion,
the first recessing portion being formed on the first surface to which the differential pressure control valve is secured,
the third path being connected to the communication path via a second recessing portion,
the second recessing portion being formed on the first surface to which the pressure decrease control valves are secured,
the second path and the third path are connected via the first path, a part of the second pipeline being configured by the first path, the second path, and the third path.
